(19) United States
(12) Patent Application Publication
(10) Pub. No.: US 2022/0351735 A1
(43) Pub. Date: Nov. 3, 2022

(54) Audio Encoding and Audio Decoding

(71) Applicant: Nokia Technologies Oy, Espoo (FI)

(72) Inventors: Mikko-Ville Laitinen, Espoo (FI); Anssi RAMO, Tampere (FI)

(21) Appl. No.: 17/761,656

(22) PCT Filed: Sep. 16, 2020
(86) PCT No.: PCT/FI2020/050592

§ 371 Date: Mar. 18, 2022

(30) Foreign Application Priority Data
Sep. 26, 2019 (GB) 1913892.4

(51) Int. Cl. G10L 19/008

(52) U.S. Cl. CPC G10L 19/008

(57) ABSTRACT

An apparatus including means for: receiving multi-channel audio signals; identifying at least one audio signal to separate from the multi-channel audio signals; separating, based on the identified at least one audio signal, the multiple audio signals into at least a first sub-set of audio signals and a second sub-set of audio signals, wherein the first sub-set includes the identified at least one audio signal and the second sub-set includes the remaining audio signals of the received multi-channel audio signals; analyzing the remaining audio signals of the second sub-set of audio signals to determine one or more transport audio signals and metadata; and encoding the at least one audio signal, transport audio signal and metadata.

### TECHNOLOGICAL FIELD

Embodiments of the present disclosure relate to audio encoding and audio decoding.

In particular, encoding multi-channel audio signals and also decoding to obtain multi-channel audio signals.

### BACKGROUND

Multi-channel audio signals comprising multiple audio signals.

In order to store or transport multi-channel audio signals it would be desirable to compress the multi-channel audio signals by encoding.

### BRIEF SUMMARY

According to various, but not necessarily all, embodiments there is provided an apparatus comprising means for:

receiving multi-channel audio signals;
identifying at least one audio signal to separate from the multi-channel audio signals; separating, based on the identified at least one audio signal, the multiple audio signals into at least a first sub-set of audio signals and a second sub-set of audio signals, wherein the first sub-set comprises the identified at least one audio signal and the second sub-set comprises the remaining audio signals of the received multi-channel audio signals;
analyzing the remaining audio signals of the second sub-set of audio signals to determine one or more transport audio signals and metadata; and
encoding the at least one audio signal, transport audio signal and metadata.

In some but not necessarily all examples the first sub-set of audio signals is a fixed sub-set of the multiple audio signals and the second sub-set of audio signals is a fixed sub-set of the multiple audio signals.

In some but not necessarily all examples the first sub-set consists of a center loud speaker channel signal and/or a pair of stereo channel signals and/or the first sub-set of audio channels comprises one or more dominantly voice audio channel signals.

In some but not necessarily all examples first sub-set of audio signals is a variable sub-set of the multiple audio signals and the second sub-set of audio signals is a variable sub-set of the multiple audio signals.

In some but not necessarily all examples a count of the first sub-set of audio signals is variable and/or a composition of the first sub-set of audio signals is variable.

In some but not necessarily all examples the first sub-set of audio signals are signals that are determined to satisfy a first criterion and the second sub-set of audio signals are signals that are determined not to satisfy the first criterion.

In some but not necessarily all examples the first criterion is dependent upon one or more first audio characteristics of the audio signals, and the first sub-set of audio signals have and share the one or more first audio characteristics and second sub-set of audio signals do not have the one or more first audio characteristics.

In some but not necessarily all examples the first criterion is dependent upon one or more spectral properties of the audio signals, and at least some of the first sub-set of audio signals share the one or more spectral properties and the second sub-set of audio signals do not share the one or spectral properties.

In some but not necessarily all examples the one or more first audio characteristics comprise an energy level of an audio signal, and the first sub-set of audio signals each have an energy level greater than any of the second sub-set of audio signals.

In some but not necessarily all examples the one or more first audio characteristics comprise audio signal correlation, and the first sub-set of audio signals each have greater cross-correlation with audio signals of the first sub-set than audio signals of the second sub-set.

In some but not necessarily all examples the one or more first audio characteristics comprise audio signal de-correlation and at least some of the first sub-set of audio signals all have low cross-correlation with other audio signals of the first sub-set and with the audio signals of the second sub-set.

In some but not necessarily all examples the one or more first audio characteristics comprise audio characteristics defined by an audio classifier, and at least some of the first sub-set of audio signals convey voice and the audio signals of the second sub-set do not.

In some but not necessarily all examples the multi-channel audio signal comprises multiple audio signals where each audio signal is for rendering audio via a different output channel.

In some but not necessarily all examples the count of the first sub-set is dependent upon an available bandwidth.

In some but not necessarily all examples, analyzing the remaining audio signals of the second sub-set of audio signals to determine transport audio signals and metadata comprises analyzing the second sub-set of audio signals but not the first sub-set of audio signals.

In some but not necessarily all examples the metadata: parameterizes time-frequency portions of the second sub-set of audio signals.

In some but not necessarily all examples the metadata encodes at least spatial energy distribution of a sound field defined by the second sub-set of audio signals.

In some examples, the analysis is parametric spatial analysis that produces metadata that is both parametric and spatial, wherein the parametric spatial analysis parameterizes time-frequency portions of the second sub-set of audio signals and at least partially encodes at least a spatial energy distribution of a sound field defined by the second sub-set of audio signals.

In some but not necessarily all examples the metadata encodes at least spatial energy distribution of a sound field defined by the second sub-set of audio signals.

In some but not necessarily all examples the apparatus comprises means for providing control information that at least identifies which one of the multiple audio signals are comprised in the first sub-set of audio signals.

In some but not necessarily all examples the control information at least identifies processed audio signals produced by the analysis.

In some but not necessarily all examples the analysis of the second sub-set of audio signals provides one or more processed audio signals and metadata, wherein the one or more processed audio signals and metadata are jointly encoded with the first sub-set of audio signals or the one or more processed audio signals and metadata are jointly encoded but encoded separately to the first sub-set of audio signals.

According to various, but not necessarily all, embodiments there is provided a method comprising coding of multi-channel audio signals, comprising:

identifying at least one audio signal to separate from the multi-channel audio signals; separating, based on the identified at least one audio signal, the multiple audio signals into at least a first sub-set of the multiple audio signals and a second sub-set of the multiple audio signals, wherein the first sub-set comprises the identified at least one audio signal and the second sub-set comprises the remaining audio signals of the received multi-channel audio signals;
analyzing the remaining audio signals of the second sub-set of audio signals to determine one or more transport audio signals and metadata; and encoding the at least one audio signal, transport audio signal and metadata.

According to various, but not necessarily all, embodiments there is provided a computer program comprising program instructions for causing an apparatus to perform at least the following:

identifying at least one audio signal to separate from multi-channel audio signals;
separating, based on the identified at least one audio signal, the multiple audio signals into at least a first sub-set of the multiple audio signals and a second sub-set of the multiple audio signals, wherein the first sub-set comprises the identified at least one audio signal and the second sub-set comprises the remaining audio signals of the received multi-channel audio signals;
analyzing the remaining audio signals of the second sub-set of audio signals to determine one or more transport audio signals and metadata; and
enabling encoding of the at least one audio signal, transport audio signal and metadata.

According to various, but not necessarily all, embodiments there is provided an apparatus comprising means for:

receiving encoded data comprising at least one audio signal, one or more transport audio signals and metadata for decoding;
decoding the received encoded data to decode the at least one audio signal, the one or more transport audio signals and the metadata;
synthesizing the decoded one or more transport audio signals and the decoded metadata to provide a set of audio signals;
identifying multi-channel indices of the at least one audio signal and/or the set of audio signals; and
combining using the indices at least the decoded at least one audio signal and the set of audio signals to provide multi-channel audio signals.

According to various, but not necessarily all, embodiments there is provided a method comprising:

receiving encoded data comprising at least one audio signal, one or more transport audio signals and metadata for decoding;
decoding the received encoded data to decode the at least one audio signal, the one or more transport audio signals and the metadata;
synthesizing the decoded one or more transport audio signals and the decoded metadata to provide a set of audio signals;
identifying multi-channel indices of the at least one audio signal and/or the set of audio signals; and
combining using the indices at least the decoded at least one audio signal and the set of audio signals to provide multi-channel audio signals.

According to various, but not necessarily all, embodiments there is provided a computer program comprising program instructions for causing an apparatus to perform at least the following:

decoding received encoded data, comprising at least one audio signal, one or more transport audio signals and metadata, to decode the at least one audio signal, the one or more transport audio signals and the metadata;
synthesizing the decoded one or more transport audio signals and the decoded metadata to provide a set of audio signals;
identifying multi-channel indices of the at least one audio signal and/or the set of audio signals; and
combining at least the decoded at least one audio signal and the set of audio signals to provide multi-channel audio signals.

According to various, but not necessarily all, embodiments there is provided an apparatus comprising means for:
receiving multi-channel audio signals for rendering spatial audio via multiple output channels, the multi-channel audio signals comprising multiple audio signals where each audio signal is for rendering audio via a different output channel;
separating the multiple audio signals into at least a first sub-set of audio signals and a second sub-set of audio signals; and
performing analysis on the second sub-set of audio signals but not the first sub-set of audio signals to provide a spatially encoded second sub-set of audio signals;

and encoding at least the first sub-set of audio signals to provide an encoded first sub-set of audio signals.

According to various, but not necessarily all, embodiments there is provided a method comprising changing audio coding of multi-channel audio signals for rendering spatial audio via multiple output channels wherein the multi-channel audio signals comprise multiple audio signals where each audio signal is for rendering audio via a spatial output channel, comprising selecting a first sub-set of the multiple audio signals and selecting a second sub-set of the multiple audio signals;

performing analysis of the second sub-set of audio signals and not the first sub-set of spatial audio signals; and
separately encoding the first sub-set of multiple audio signals.

According to various, but not necessarily all, embodiments there is provided a computer program comprising program instructions for causing an apparatus to perform at least the following:

selecting a first sub-set and a second sub-set of multiple audio signals for rendering spatial audio via multiple output channels wherein the multi-channel audio signals comprise multiple audio signals where each audio signal is for rendering audio via a spatial output channel;
performing analysis of the second sub-set of audio signals and not the first sub-set of spatial audio signals;
enabling encoding of the first sub-set of multiple audio signals.

According to various, but not necessarily all, embodiments there is provided an apparatus comprising means for:
decoding an encoded first sub-set of audio signals to produce a first sub-set of audio signals;
decoding a spatially encoded second sub-set of audio signals to produce a second sub-set of audio signals;
combining the first sub-set of audio signals and the second sub-set of audio signals to synthesize multiple audio signals for rendering spatial audio via multiple output channels, where each audio signal is for rendering audio via a different output channel.

According to various, but not necessarily all, embodiments there is provided a method comprising:
decoding an encoded first sub-set of audio signals to produce a first sub-set of audio signals;
decoding a spatially encoded second sub-set of audio signals to produce a second sub-set of audio signals;
combining the first sub-set of audio signals and the second sub-set of audio signals to synthesize multiple audio signals for rendering spatial audio via multiple output channels, where each audio signal is for rendering audio via a different output channel.

According to various, but not necessarily all, embodiments there is provided a computer program comprising program instructions for causing an apparatus to perform at least the following:
decoding an encoded first sub-set of audio signals to produce a first sub-set of audio signals;
decoding a spatially encoded second sub-set of audio signals to produce a second sub-set of audio signals;
combining the first sub-set of audio signals and the second sub-set of audio signals to synthesize multiple audio signals for rendering spatial audio via multiple output channels, where each audio signal is for rendering audio via a different output channel.

According to various, but not necessarily all, embodiments there is provided an apparatus comprising means for:
receiving multi-channel audio signals for rendering spatial audio via multiple output channels, the multi-channel audio signals comprising multiple audio signals where each audio signal is for rendering audio via a different output channel;
separating the multiple audio signals into at least a first sub-set of audio signals and a second sub-set of audio signals;
providing a first encoding path for encoding the first sub-set of audio signals and a second different encoding path for encoding the second sub-set of audio signals, wherein the second encoding path, but not the first encoding path, comprises performing analysis.

According to various, but not necessarily all, embodiments there is provided a method comprising audio coding of multi-channel audio signals for rendering spatial audio via multiple output channels wherein the multi-channel audio signals comprise multiple audio signals where each audio signal is for rendering audio via a spatial output channel, comprising:

selecting a first sub-set of the multiple audio signals and selecting a second sub-set of the multiple audio signals;
providing a first encoding path for encoding the first sub-set of audio signals and a second different encoding path for encoding the second sub-set of audio signals,
wherein the second encoding path, but not the first encoding path, comprises performing analysis.

According to various, but not necessarily all, embodiments there is provided a computer program comprising program instructions for causing an apparatus to perform at least the following:

selecting a first sub-set and a second sub-set of multiple audio signals for rendering spatial audio via multiple output channels wherein the multi-channel audio signals comprise multiple audio signals where each audio signal is for rendering audio via a spatial output channel;
providing a first encoding path for encoding the first sub-set of audio signals and a second different encoding path for encoding the second sub-set of audio signals, wherein the second encoding path, but not the first encoding path, comprises performing analysis. analysis

According to various, but not necessarily all, embodiments there is provided an apparatus comprising means for:
receiving multi-channel audio signals for rendering spatial audio via multiple output channels, the multi-channel audio signals comprising multiple audio signals where each audio signal is for rendering audio via a different output channel;
separating the multiple audio signals into at least a first sub-set of audio signals and a second sub-set of audio signals;
providing a first encoding path for encoding the first sub-set of audio signals and a second different encoding path for encoding the second sub-set of audio signals, wherein the second encoding path, but not the first encoding path, comprises performing analysis, wherein the first encoding path, after analysis, and the second encoding path use a joint encoder or wherein the first encoding path, after analysis, and the second encoding path use separate encoders.

According to various, but not necessarily all, embodiments there is provided examples as claimed in the appended claims.

### BRIEF DESCRIPTION

Some examples will now be described with reference to the accompanying drawings in which:

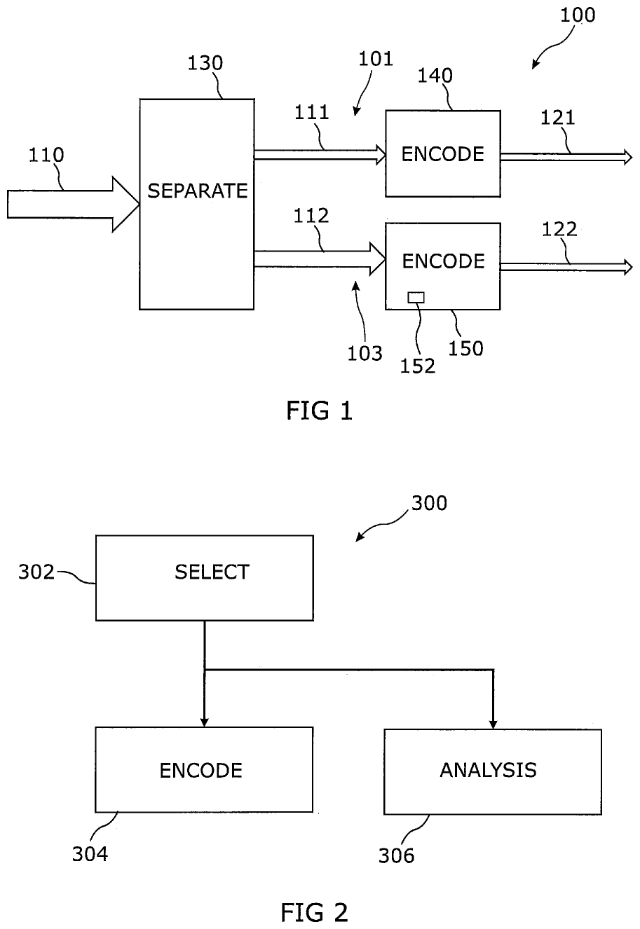

FIG. 1 shows an example of the subject matter described herein;

FIG. 2 shows another example of the subject matter described herein;

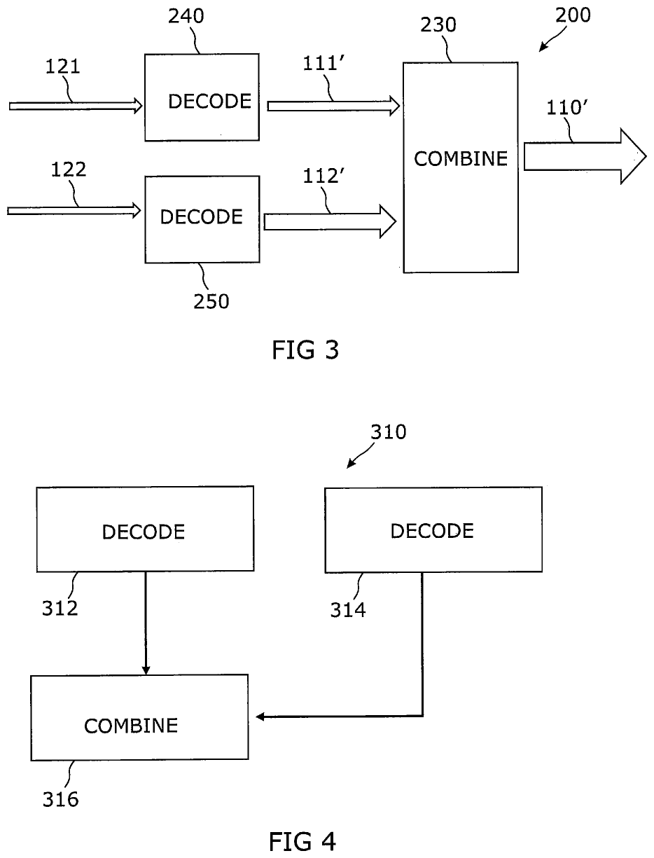

FIG. 3 shows another example of the subject matter described herein;

FIG. 4 shows another example of the subject matter described herein;

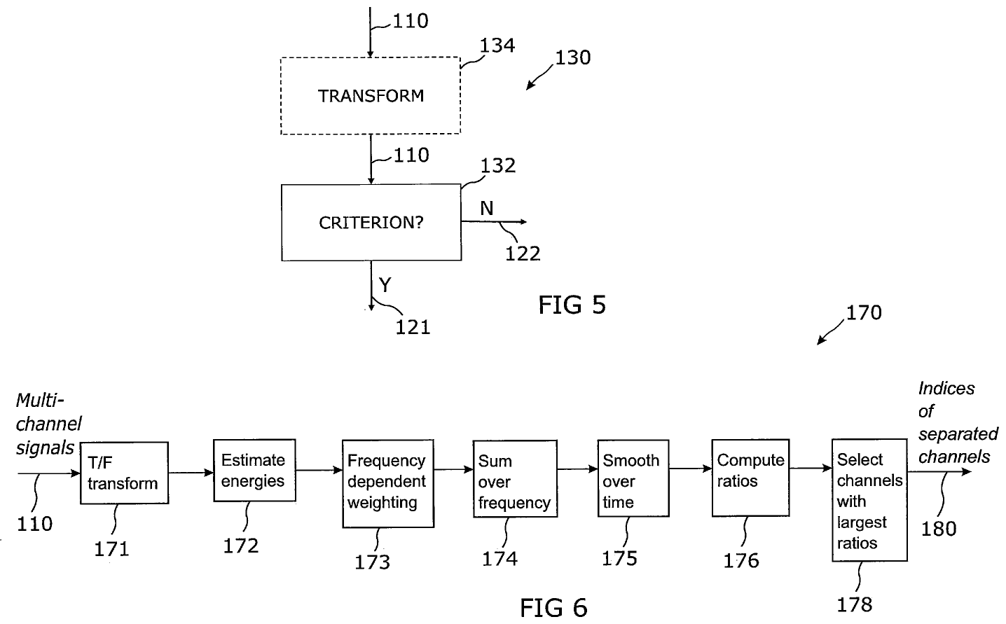

FIG. 5 shows another example of the subject matter described herein;

FIG. 6 shows another example of the subject matter described herein;

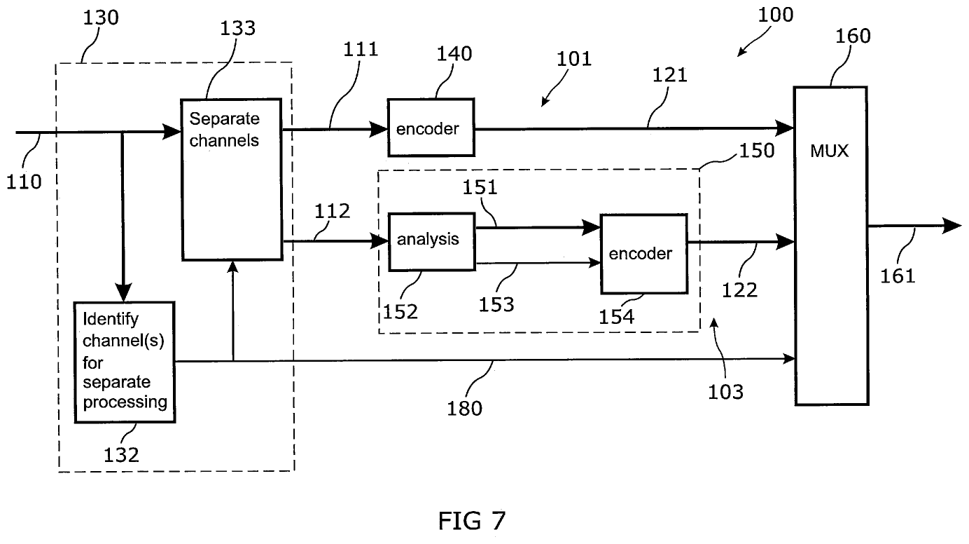

FIG. 7 shows another example of the subject matter described herein;

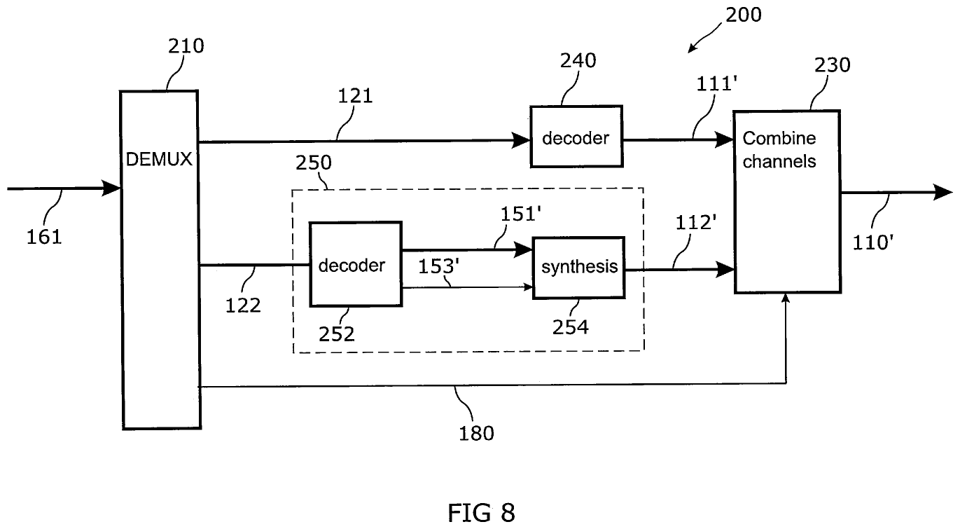

FIG. 8 shows another example of the subject matter described herein;

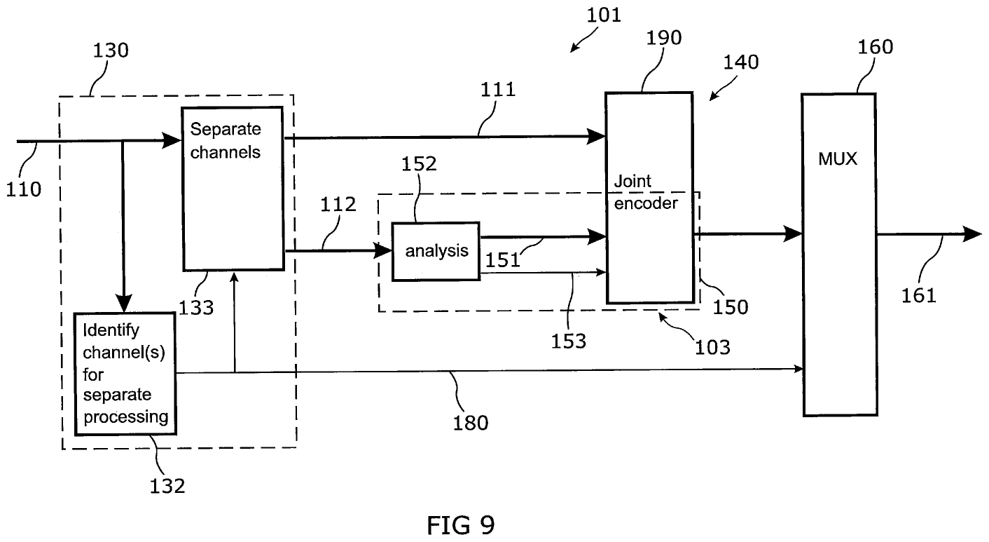

FIG. 9 shows another example of the subject matter described herein;

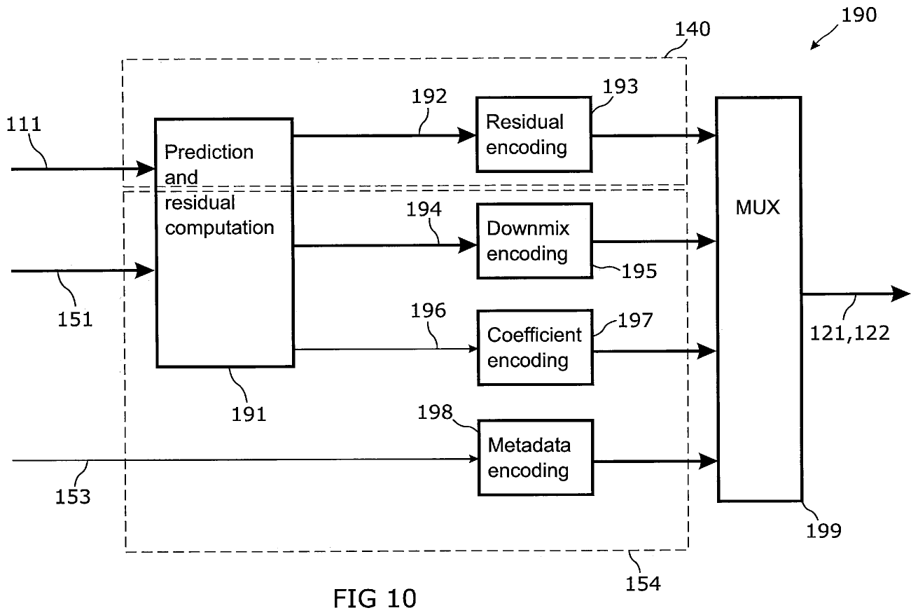

FIG. 10 shows another example of the subject matter described herein;

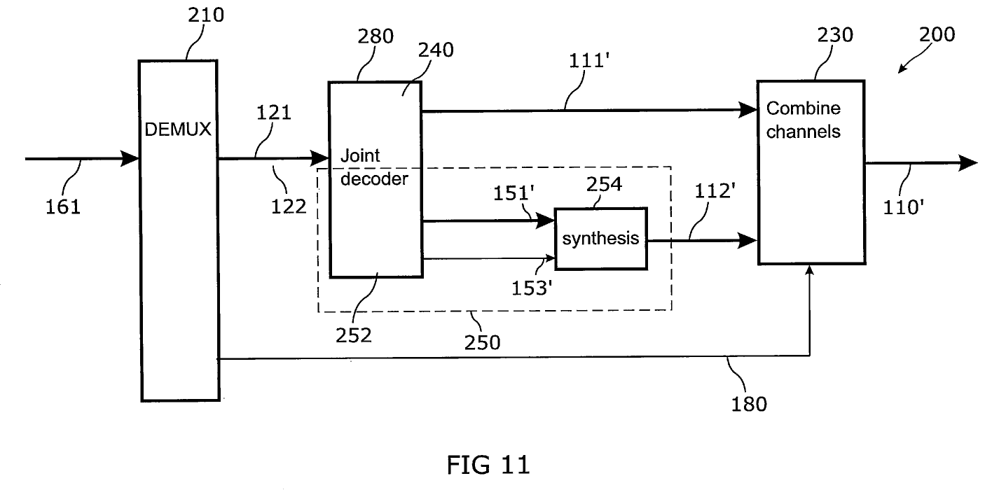

FIG. 11 shows another example of the subject matter described herein;

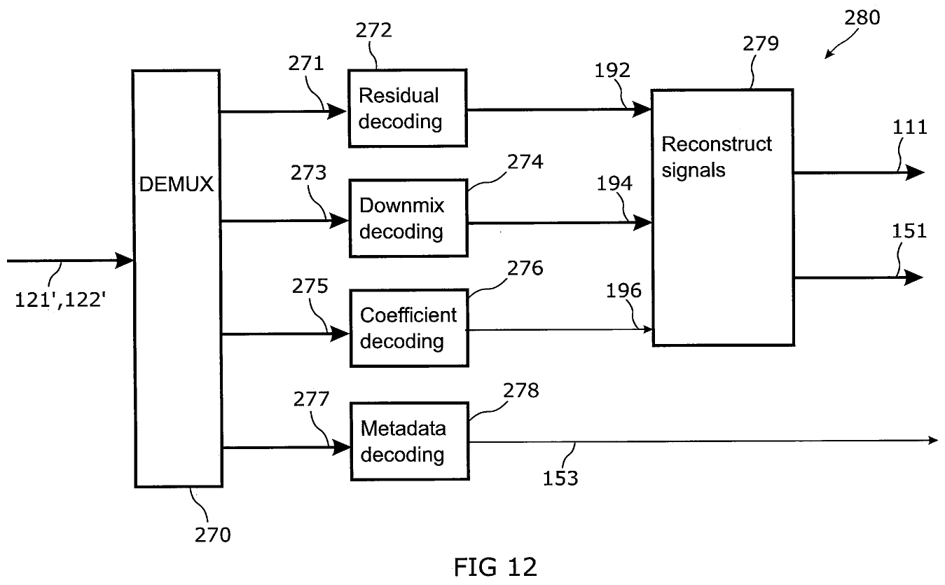

FIG. 12 shows another example of the subject matter described herein;

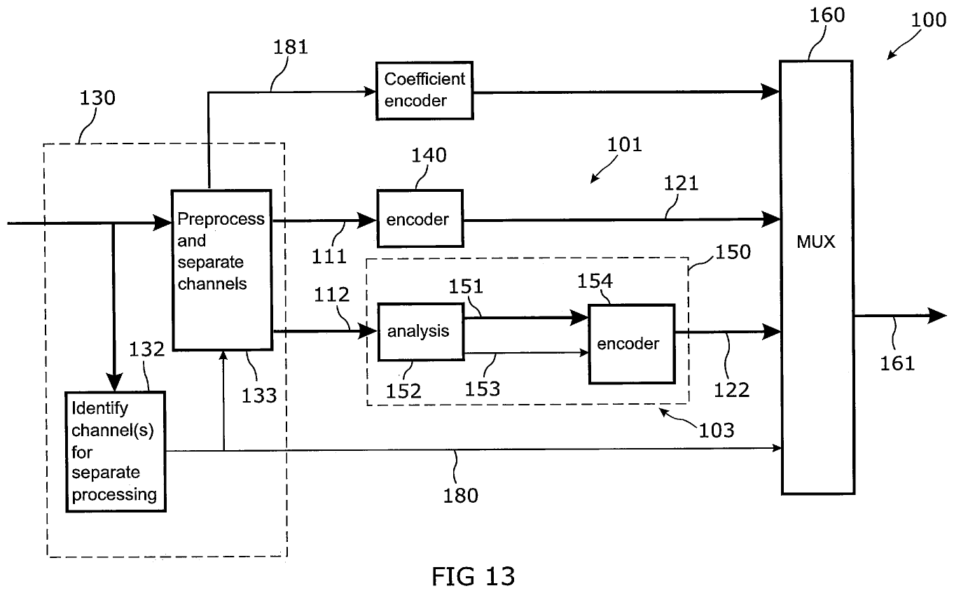

FIG. 13 shows another example of the subject matter described herein;

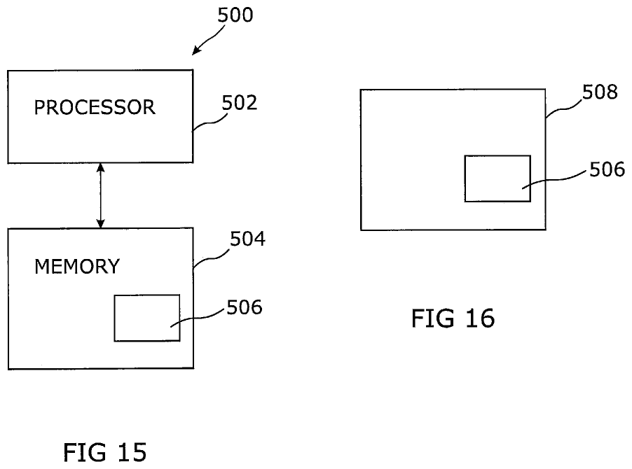

FIG. 15 shows another example of the subject matter described herein;

FIG. 16 shows another example of the subject matter described herein.

### DETAILED DESCRIPTION

FIG. 1 illustrates an example of an apparatus 100. The apparatus 100 is an audio encoder apparatus configured to encode multi-channel audio signals 110.

The apparatus 100 is configured to receive multi-channel audio signals 110. In at least some examples, the received multi-channel audio signals 110 are multi-channel audio signals 110 for rendering spatial audio via multiple output channels. In at least some examples, the multi-channel audio signals 110 comprise multiple audio signals 110 and each audio signal 110 is for rendering audio via a different output channel.

The apparatus 100 comprises circuitry for performing functions. The functions comprise:

at block 130, separating the multiple audio signals 110 into at least a first sub-set 111 of audio signals 110 and a second sub-set 112 of audio signals 110;
at block 150, performing analysis 152 on the second sub-set 112 of audio signals 110 but not the first sub-set 111 of audio signals 110 before subsequent encoding provides an encoded second sub-set 122 of audio signals 110; and
at block 140, encoding at least the first sub-set 111 of audio signals 110 to provide an encoded first sub-set 121 of audio signals 110.

The apparatus 100 provides a first encoding path 101 for encoding the first sub-set 111 of audio signals 110 and a second different encoding path 103 for encoding the second sub-set 112 of audio signals 110. The second encoding path 103, but not the first encoding path 101 comprises performing analysis 152.

Although in this example, the encoding of the first sub-set 111 of audio signals 110 is illustrated as separate to the second sub-set 112 of audio signals 110, in other examples after the analysis 152 of the second sub set 112 of audio signals 110, joint encoding of the analyzed second sub-set 112 of audio signals 110 and the first sub-set 111 of audio signals 110 can occur, as will be described later.

### Multi-Channel Audio Signals

In some but not necessarily all examples, the multi-channel audio signals 110 comprise multiple audio signals 110 and each audio signal 110 is configured to render audio via a different loudspeaker channel. Examples of these multi-channel audio signals 110 comprise 5.1, 5.1+2, 5.1+4, 7.1, 7.1+4, etc.

In some but not necessarily all examples, the multi-channel audio signals 110 comprise multiple audio signals 110 and each audio signal 110 represents a virtual microphone. Examples of these multi-channel audio signals 110 can comprise Higher Order Ambisonics.

The multi-channel audio signals 110 can for example be received after being converted from a different spatial audio format, such as an object-based audio format.

The multi-channel audio signals 110 can for example be received after being accessed from memory storage by the apparatus 100 or received after being transmitted to the apparatus 100.

### Fixed

In some examples the apparatus 100 has a fixed (non-adaptive) operation and is configured to separate 130 the multiple audio signals 110 in the same way over time. The separation can be permanently fixed or temporarily fixed. If temporarily fixed, it can be fixed by the user. It does not adapt based on the content of the multiple audio signals 110.

For example, in some but not necessarily all examples the apparatus 100 separating 130 the multiple audio signals 110 into at least the first sub-set 111 of audio signals 110 and the second sub-set 112 of audio signals 110 is fixed, that is the first sub-set 111 of audio signals 110 is a fixed sub-set of the multiple audio signals 110 and the second sub-set 112 of audio signals 110 is a fixed sub-set of the multiple audio signals 110.

The first sub-set 111 can comprise a single audio signal, for example, a center loud speaker channel signal. The first sub-set can comprise a pair of audio signals, for example, a pair of stereo channel signals.

The first sub-set 111 can comprise one or more dominantly voice audio channel signals, or other source-dominated audio signals that are dominated by one or more audio sources and best capture the one or more sources, which could be, for example, a lead instrument, singing, or some other type of audio source.

### Adaptive

In some examples the apparatus 100 has an adaptive operation and is configured to separate 130 the multiple audio signals 110 dynamically, that is, in different ways over time. The separation is adaptive in that the apparatus 100 itself controls the adaptation. For example, the apparatus 100 can adapt separation 130 of the multiple audio signals 110 based on the content of the multiple audio signals 110.

For example, in some but not necessarily all examples the apparatus 100 separating 130 the multiple audio signals into at least the first sub-set 111 of audio signals 110 and the second sub-set 112 of audio signals 110 is adaptive (over time), wherein first sub-set 111 of audio signals 110 is a variable sub-set of the multiple audio signals 110 and the second sub-set 112 of audio signals 110 is a variable sub-set of the multiple audio signals 110.

The sub-set 111 of audio signals 110 can be varied by changing a count (the number) of the first sub-set 111 of audio signals 110. The first sub-set 111 can comprise a single audio signal 110, a pair of audio signals 110, or more audio signals 110.

The sub-set 111 of audio signals 110 can be varied by changing a composition (the identity) of the first sub-set 111 of audio signals 110. The first sub-set 111 can, for example, map to different combinations of the multiple audio signals 110.

In some but not necessarily all example, the separating 130 of the audio signals 110 is dependent upon available bandwidth. For example, the count of the first sub-set 111 of audio channels and/or the composition of the first sub-set 111 of audio channels 110 can be dependent upon an available bandwidth. The apparatus 100 can, for example, adapt to changes in available bandwidth by adapting separation 130 of the audio signals 110.

As an example, the multi-channel audio signals 110 can have a 7.1 surround sound format. There are 7 audio signals 110 of which 1 audio channel is a central audio signal 110. The table below illustrates some examples of how the count of the first sub-set 111 can be varied. The table below illustrates how the bandwidth allocated to the first subset 111 of audio channels 110 can be varied. The table illustrates how the division of the available bandwidth between the first sub-set 111 of audio signals 110 and the second subset 112 of audio signals 110 can be varied.

| | Bandwidth for | | Bandwidth for |
|---|---|---|---|
| Available | each audio signal | Count of audio | second sub-set |
| bandwidth | 110 in the first | signals 110 in the | 112 of audio |
| (kbps) | sub-set 111 | first sub-set 111 | signals 110 |
| 32 | 12 | 1 | 20 |
| 48 | 16 | 1 | 32 |
| | 12 | 2 | 24 |
| 64 | 20 | 1 | 44 |
| | 24 | 1 | 40 |
| 80 | 24 | 1 | 56 |
| | 20 | 2 | 40 |
| 96 | 32 | 1 | 64 |
| | 24 | 2 | 48 |
| 128 | 48 | 1 | 80 |
| | 32 | 2 | 64 |
| | 24 | 3 | 56 |
| 160 | 48 | 1 | 112 |
| | 40 | 2 | 80 |
| | 32 | 3 | 64 |
| | 28 | 4 | 48 |

In some examples, there may be a minimum bandwidth for each audio signal 110 in the first sub-set 111. A suitable minimum bandwidth can, in some examples, be 9.6 kbps or 10 kbps.

In some examples, there may be a minimum bandwidth for the second sub-set 112 of audio signals 110. A suitable minimum bandwidth can, in some examples, be 20 kbps.

The first sub-set 111 of audio signals 110 can be encoded at a variable bit rate per audio signal. Alternatively or in addition the second sub-set 112 of audio signals 110 can be encoded at a variable bit rate. The bit rate allocation between the first sub-set 111 and the second sub-set 112 can be controlled so that optimal perceptual quality is achieved.

FIG. 2 illustrates an example of a method 300 that can be performed by the apparatus 100. The method 300 changes audio coding of multi-channel audio signals 110 for rendering spatial audio via multiple output channels. The multi-channel audio signals 110 comprise multiple audio signals 110 and each audio signal is for rendering audio via a spatial output channel.

The method comprises, at block 302, selecting 302 a first sub-set 111 of the multiple audio signals 110 and selecting 302 a second sub-set 112 of the multiple audio signals 110.

The method comprises, at block 306, performing analysis of the second sub-set 112 of audio signals 110 and not the first sub-set 111 of spatial audio signals 110.

The method comprises, at block 304, encoding at least the first sub-set 111 of multiple audio signals 110.

In some examples, the first sub-set 111 of multiple audio signals 110 is separately encoded to the second sub-set 112 of multiple audio signals 110. In some examples, the first sub-set 111 of multiple audio signals 110 is jointly encoded with the second sub-set 112 of multiple audio signals 110 after analysis of the second sub-set 112 of audio signals 110.

FIG. 3 illustrates an example of an apparatus 200. The apparatus 200 is an audio decoder apparatus configured to decode the encoded first sub-set 121 of audio signals 110 and the encoded second sub-set 122 of audio signals 110 to synthesize multi-channel audio signals 110′.

The apparatus 200 comprises circuitry for performing functions.

The apparatus 200 decodes 240 an encoded first sub-set 121 of audio signals 110 to produce a first sub-set 111′ of audio signals 110.

The apparatus 200 decodes 250 an encoded second sub-set 122 of audio signals 110 to produce a second sub-set 112′ of audio signals 110.

The first sub-set 111′ of audio signals 110 and the second sub-set 112′ of audio signals 110 are combined to synthesize multiple audio signals 110′ for rendering spatial audio via multiple output channels, where each audio signal 110′ is for rendering audio via a different output channel.

FIG. 4 illustrates an example of a method 310 that can be performed by the apparatus 200.

The method 310 comprises, at block 312, decoding an encoded first sub-set 121 of audio signals 110 to produce a first sub-set 111′ of audio signals 110.

The method 310 comprises, at block 314, decoding an encoded second sub-set 122′ of audio signals 110 to produce a second sub-set 112′ of audio signals 110.

The method 310 comprises, at block 316, combining the first sub-set 111′ of audio signals 110 and the second sub-set 112′ of audio signals 110 to synthesize multiple audio signals 110′ for rendering spatial audio via multiple output channels, where each audio signal 110′ is for rendering audio via a different output channel.

The separating 130 of the audio signals 110 into the first sub-set 111 and the second sub-set 112, as described in relation to FIGS. 1 & 2, can be based on an evaluation of a criterion. The criterion can, for example, be a simple single criterion or can be a logical criterion that uses Boolean logic to define more complex conditional statements as the criterion. The criterion can therefore be dependent upon one or more parameters.

In the example illustrated in FIG. 5, the first sub-set 111 of audio signals 110 are signals that are determined, at block 132, to satisfy the criterion and the second sub-set 112 of audio signals 110 are signals that are determined, at block 132, not to satisfy the criterion.

In some examples, the assessment of the audio signals 110 at block 132 is frequency independent (broadband). In other examples, the assessment of the audio signals 110 at block 132 is frequency dependent and the audio signals 110 are transformed 134 from a time domain to a frequency domain before assessment of the criterion at block 132.

The first criterion can, for example, be dependent upon one or more audio characteristics of the audio signals 110. Thus, in some examples, the first sub-set 111 of audio signals 110 share the one or more audio characteristics and second sub-set 112 of audio signals 110 do not share the one or more first audio characteristics.

The first criterion can be dependent upon one or more spectral characteristics of the audio signals 110. Thus, in some examples at least some of the first sub-set 111 of audio signals 110 share the one or more spectral characteristics and the second sub-set 112 of audio signals 110 do not share the one or more spectral properties.

The first criterion can be dependent upon both audio characteristics and spectral characteristics. For example, the first sub-set 111 of audio signals can share audio characteristics within a first frequency range that are not shared by second sub-set 112 of audio signals 110.

In some examples, the one or more audio characteristics comprise an energy level of an audio signal 110. Thus, in some examples, the first sub-set 111 of audio signals 110 each have an energy level greater than any of the second sub-set 112 of audio signals 110. In some examples, the first sub-set 111 of audio signals 110 each have an energy level greater than any of the second sub-set 112 of audio signals 110 and, in addition, greater than a threshold value. In some examples, the energy level is determined only within a defined frequency band or defined frequency bands. For example, the defined frequency band could correspond to human speech.

In some examples, the one or more audio characteristics identify dialogue or other prominent audio, so that the first sub-set 111 comprises dialogue/most prominent audio signals 110.

In some examples, the one or more first audio characteristics comprise audio signal correlation. Thus, in some examples, the first sub-set 111 of audio signals 110 each have greater cross-correlation with audio signals 110 of the first sub-set than audio signals 110 of the second sub-set. This can for example occur when a prominent audio content is on multiple channels simultaneously. The prominence is therefore arising from a wider spatial distribution compared to other audio content.

In some examples, the one or more first audio characteristics comprise audio signal de-correlation. Thus, in some examples, at least some of the first sub-set 111 of audio signals 110 all have low cross-correlation with other audio signals 110 of the first sub-set and with the audio signals 110 of the second sub-set. This can for example occur when prominent audio content is on only a single channel. The prominence is therefore arising from a narrower spatial distribution compared to other audio content.

In some examples, the one or more first audio characteristics comprise audio characteristics defined by an audio classifier. The audio classifier can for example be configured to classify sound sources. The audio classifier can therefore identify audio signals 110 that include (predominantly) human voice, or an instrument, or speech or singing or some other type of audio source. Thus at least some of the first sub-set 111 of audio signals 110 can convey a particular sound source where the audio signals 110 of the second sub-set 112 do not.

FIG. 6 illustrates an example of a more detailed method for assessing a criterion for separating 130 of the audio signals 110 into the first sub-set 111 and the second sub-set 112.

The input to the method is the multi-channel signals s(i, m), where i is the index of an audio signal 110 for a channel and m is the time index. First, at block 171, the signals 110 are transformed from the time domain to the time-frequency domain. This can be performed, e.g., using short-time Fourier transform (STFT), or, e.g., the complex quadrature mirror filterbank (QMF). The resulting time-frequency domain signals are denoted as S(i, b, n), where b is the frequency bin index, and n is the temporal frame index.

At block 172, the energies E(i, k, n) of the time-frequency domain input signals S(i, b, n) are estimated in frequency bands

$$E ( i , k , n ) = {\sum }_{{b}_{k , low}}^{{b}_{k , high}} {\vert S ( i , b , n ) \vert}^{2}$$

where k is the frequency band index, b_{k,low} is the lowest bin of the frequency band, and b_{k,high} is the highest bin.

At optional block 173, the energies E(i, k, n) can be weighted with frequency-dependent weighting in order to, for example, focus more to certain frequencies, for example, the speech frequency range. As another example, a weighting may be applied to mimic the loudness perception of human hearing. The weighting can be performed by

E_{w}(i,k,n)=E(i,k,n)w(k)
where w(k) is the weighting function.

At block 174, the weighted energies are summed over frequency bands in order to obtain a broadband estimate

$${E}_{w} ( i , n ) = {\sum }_{k} {E}_{w} ( i , k , n ) .$$

At block 175, the broadband estimates are smoothed over time, e.g., by

E_{w,sm}(i,n)=aE_{w}(i,n)+bE_{w,sm}(i,n−1)
where a and b are smoothing coefficients (e.g., a=0.01 and b=1−a).

Next, at block 176, ratios of the energy for audio signals 110 of certain channels i versus the total energy of all channels are computed

$$r ( i , n ) = \frac{{E}_{w , sm} ( i , n )}{{\sum }_{i} {E}_{w , sm} ( i , n )} .$$

Finally, at block 178, the indices i of the audio signals 110 to be separated to the first sub-set 111 are selected using r(i,n). The indices can be provided as control information 180 for use in separating the multiple audio signals 110 into the first sub-set 111 of audio signals 110 and the second sub-set 112 of audio signals 110. As an example, the audio signal 110 with the largest ratio r(i, n) can be selected. As another option, the audio signal 110 with the largest ratio r(i, n) can be selected if it is above a certain threshold τ (e.g., τ=0.2). If the largest audio signal 110 is below the threshold, no channels are to be separated to the first sub-set 111.

As another example, more than one audio signal 110 can be selected to be separated to the first sub-set 111. For example, the two audio signals with the largest ratios r(i, n) may be selected. The selection may also be “paired” so that audio signals 110 for symmetrical channels (e.g., front left and front right) are considered together (in order not to disturb the stereo image). In this case, both the audio signals 110 for the symmetrical channels may need to have ratios r(i,n) above the threshold T.

As another example, the audio signal 110 for the centre channel is separated to the first sub-set 111 if it has a ratio r(i, n) above a threshold.

Hence, audio signals 110 to be separated to the first sub-set 111 can be flexibly selected, and there may be multiple approaches to the selection.

The selection made, if fixed or flexible, needs to be known at the decoder which identifies multi-channel indices of the first sub-set 111 and/or the second sub-set 112 or otherwise defines a relationship or mapping of the first and/or second sub-set 111, 112 of audio signals 110 to multi-channel audio signals.

The selection can be dependent on the bit rate available for use. For example, when higher bit rates are available more audio signals 110 can be separated to the first sub-set on average.

FIG. 7 illustrates an example of the apparatus 100, previously described. Similar references are used to describe similar components and functions.

The apparatus 100 comprises circuitry for performing functions. The functions comprise:

identifying 132 at least one audio signal to separate from the multi-channel audio signals;
separating 130, based on the identified at least one audio signal, the multiple audio signals 110 into at least a first sub-set 111 of audio signals 110 and a second sub-set 112 of audio signals 110 wherein the first sub-set 111 comprises the identified at least one audio signal and the second sub-set comprises the remaining audio signals of the received multi-channel audio signals 110;
analyzing 152 the remaining audio signals of the second sub-set 112 of audio signals 110 to determine one or more transport audio signals 151 and metadata 153; and
encode 140, 154 the at least one identified audio signal of the first sub-set 111, the one or more transport audio signal 151 and the metadata 152.

The features illustrated in FIG. 7 include: blocks 132, 133 within block 130 illustrate block for logical separation 132 and physical separation 133 of the audio signals 110; blocks 152, 154 within block 150 illustrate analysis 152 and encoding 154 of the second sub-set 112 of audio signals 110; and multiplexer 160 combines not only the encoded first sub-set 121 of audio signals and the encoded second sub-set 122 of audio signals 122 but also control information 180 from block 132 to form a data stream 161.

The block 152 performs analysis of the second sub-set 112 of audio signals 110 but not the first sub-set 111 of audio signals 110 to provide one or more processed (transport) audio signals 151 and metadata 153. The provided one or more processed (transport) audio signals 151 and metadata 153 are encoded at block 154 to provide the encoded second sub-set 122 of audio signals 110.

The processing 152 of the audio signals 110 to form the processed audio signals 151 can, for example, comprise downmixing or selection. The processed audio signals 151 for transport can be, for example, a downmix of some or all of the audio signals in the second sub-set 112 of audio signals 110. Alternatively, the processed audio signals 151 for transport can be, for example, a selected sub-set of the audio signals 110 in the second sub-set 112 of audio signals 110.

In some but not necessarily all examples, the block 152 performs spatial audio encoding. For example, block 152 can comprise one or more metadata assisted spatial audio (MASA) codecs, or analyzers, or processors or pre-processors. A MASA codec produces two processed audio signals 151 for transport.

In some but not necessarily all examples, the metadata 153 parameterizes time-frequency portions of the second sub-set 112 of audio signals 110. For example, in some examples, the metadata 153 encodes at least spatial energy distribution of a sound field defined by the second sub-set 112 of audio signals 110.

The metadata 153 can, for example, encode one or more of the following parameters:

a direction index that defines direction of sound;
a direction/energy (ratio) that provides an energy ratio for a direction specified by the direction index e.g. energy in direction/total energy;
sound-field information;
coherence information (such as spread and/surrounding coherences);
diffuseness information;
distances.

The parameters can be provided in the time-frequency domain.

The metadata 153 for metadata assisted spatial audio can use one or more of the following parameters:

i) Direction index: direction of arrival of the sound at a time-frequency parameter interval. Spherical representation at about 1-degree accuracy;
ii) Direct-to-total energy ratio: Energy ratio for the direction index (i.e., time-frequency subframe). Calculated as energy in direction/total energy;
iii) Spread coherence: Spread of energy for the direction index (i.e., time-frequency subframe). Defines the direction to be reproduced as a point source or coherently around the direction.
iv) Diffuse-to-total energy ratio: Energy ratio of non-directional sound over surrounding directions. Calculated as energy of non-directional sound/total energy
v) Surround coherence: Coherence of the non-directional sound over the surrounding directions;
vi) Remainder-to-total energy ratio: Energy ratio of the remainder (such as microphone noise) sound energy to fulfil requirement that sum of energy ratios is calculated as energy of remainder sound/total energy;
vii) Distance: Distance of the sound originating from the direction index (i.e., time-frequency subframes) in meters on a logarithmic scale.

The functionality of separating 130 the audio channels 110 comprises a sub-block 132 for determining the logical separation of the audio channels 110 into the first sub-set 111 and the second sub-set 112 and a sub-block 133 for physically separating the audio channels 110 into the first encoding path 101 for the first sub-set 111 of audio signals 110 and the second encoding path 103 for the second sub-set 112 of audio signals 110.

In some but not necessarily all examples, the sub-block 132 analyses the multiple audio signals 110. For example, it determines whether or not received audio signals 110 satisfy a criterion, as previously described. The sub-block 133 can logically separate the audio signals 110 into the first sub-set 111 and the second sub-set 112. For example, the first sub-set 111 of audio signals 110 are determined to satisfy the criterion and the second sub-set 112 of audio signals 110 are signals that are determined (explicitly or implicitly) to not satisfy the criterion.

The sub-block 132 produces control information 180 that at least identifies the logical separation of the audio signals 110 into the first sub-set 111 and the second sub-set 112. The control information 180 at least identifies which one of the multiple audio signals 110 are comprised in the first sub-set 111 of audio signals 110.

In some examples the control information 180 at least identifies processed audio signals 151 produced by the analysis 152.

In some examples the control information 180 at least identifies the metadata, for example, identifying the type of, or parameters for analysis.

FIG. 8 illustrates a decoder apparatus 200 for use with the encoder apparatus 100 illustrated in FIG. 7. FIG. 8 illustrates an example of the apparatus 200, previously described. Similar references are used to describe similar components and functions.

The apparatus 200 is an audio decoder apparatus configured to decode the encoded first sub-set 121 of audio signals 110 and the encoded second sub-set 122 of audio signals 110 to synthesize multi-channel audio signals 110′.

The apparatus 200 comprises circuitry for performing functions. The functions comprise:

The functions comprise:

receiving encoded data 161 comprising at least one audio signal 111, one or more transport audio signals 151 and metadata 153 for decoding;
decoding 240, 250 the received encoded data 161 to provide a decoded at least one audio signal 111′ as a first sub-set 111′ of audio signals 110′, a decoded one or more transport audio signals 151′ and decoded metadata 153′;
synthesizing 254 the decoded one or more transport audio signals 151′ and the decoded metadata 153′ to provide a second sub-set of audio signals 112′;
identifying multi-channel indices of the at least one audio signal and/or the set of audio signals; and
combining 230 at least the decoded at least one audio signal 111′ (the first sub-set) and the second sub-set of audio signals 112′ to provide multi-channel audio signals 110′.

The features illustrated in FIG. 8 include:

de-multiplexer 210 recovers the encoded first sub-set 121 of audio signals, the encoded second sub-set 122 of audio signals 110 and the control information 180 from the received data stream 161;
decoding 240 the encoded first sub-set 121 of audio signals to provide at least one audio signal as a first sub-set 111′ of audio signals 110′;
blocks 252, 254 within block 250 illustrate decoding 252 and synthesis 254 of the encoded second sub-set 122 of audio signals 110 to recover the second sub-set 112′ of audio signals 110; combining 230 the first sub-set 111′ of audio signals 110 and the second sub-set 112′ of audio signals 110 to synthesize multiple audio signals 110′ is dependent upon the received control information 180.

The encoded second sub-set 122 of audio signals 110 is decoded at block 252 to provide one or more processed (transport) audio signals 151′ and metadata 153′.

The block 254 performs synthesis on the processed (transport) audio signals 151′ and metadata 153′ to synthesize the second sub-set 112′ of audio signals 110.

In some but not necessarily all examples, the block 254 comprises one or more metadata assisted spatial audio (MASA) codecs, or synthesizers, or renderers or processors. A MASA codec decodes two processed audio signals 151 for transport and metadata 153.

The functionality of combining 230 the first sub-set 111′ of audio signals 110 and the second sub-set 112′ of audio signals 110 to synthesize multiple audio signals 110′ can be dependent upon the received control information 180. The control information 180 defines the logical separation of the audio channels 110 into the first sub-set 111 and the second sub-set 112. The control information can, for example, identify multi-channel indices of the at least one audio signal and/or the set of audio signals.

In some examples the control information 180 at least identifies processed audio signals 151 produced by the analysis 152. In this example, the control information 180 is provided to block 254.

In some examples the control information 180 at least identifies the metadata 153, for example, identifying the type of, or parameters for analysis. In this example, the control information 180 is provided to block 254.

In the example of FIG. 7, analysis 152 of the second sub-set 112 of audio signals 110 but not the first sub-set 111 of audio signals 110 provides one or more processed audio signals 151 and metadata 153. In the example of FIG. 7, the one or more processed audio signals 151 and metadata 153 are not jointly encoded with the first sub-set 111 of audio signals 110. The first encoding path 101 for the first sub-set 111 of audio signals 110 and the second encoding path 103 for the second sub-set 112 of audio signals 110 re-join at the multiplexer 160.

The apparatus 100 illustrated in FIG. 9 is similar to the apparatus 100 illustrated in FIG. 7. However, in FIG. 9, the one or more processed audio signals 151 and metadata 153 are jointly encoded with the first sub-set 111 of audio signals 110 at a joint encoder 190. The first encoding path 101 for the first sub-set 111 of audio signals 110 and the second encoding path 103 for the second sub-set 112 of audio signals 110 re-join at the joint encoder 190. The joint encoder 190 replaces blocks 140, 154 in FIG. 7.

FIG. 10 illustrates an example of a joint encoder 190. In a joint encoder 190 possible interdependencies between the first set 111 of audio signals 110 and the processed (transport) audio signals 151 can be taken into account while encoding them.

The signals of the first set 111 of audio signals 110 and the one or more transport audio signals 151 are forwarded to computation block 191. Block 191 combines those signals 111, 151 to one or more downmix signals 194 and residual signals 192. In addition, prediction coefficients 196 are output. In a decoder, the original signals 111, 151 can be derived from the downmix signals 194 using the prediction coefficients 196 and the residual signals 192. Details of prediction and residual processing can be found in the publicly available literature.

The residual signals 192 are forwarded to block 193 for encoding. The downmix signals are 194 forwarded to block 195 for encoding. The residual coefficients 196 are forwarded to block 197 for encoding. The metadata 153 is encoded at block 198.

The encoded residual signals, encoded downmix signals, encoded residual coefficients and encoded metadata 153 are provided to a multiplexer 199 which outputs a data stream including the encoded first set 121 of audio signals 110 and the encoded second set 122 of audio signals.

FIG. 11 illustrates a decoder apparatus 200 for use with the encoder apparatus 100 illustrated in FIG. 9. The apparatus 200 illustrated in FIG. 11 is similar to the apparatus 200 illustrated in FIG. 8. However, in FIG. 11, a received jointly encoded data stream 121, 122 comprises the encoded first sub-set 121 of audio signals 110 and the encoded second sub-set 122 of audio signals 110.

A joint decoder 280 decodes the jointly encoded data stream and creates a first decoding path for the first sub-set 111′ of audio signals 110 and a second decoding path for the second sub-set 112′ of audio signals 110. The one or more processed audio signals 151′ and metadata 153′ are provided in the second decoding path by the joint decoder 280 to block 254. The joint decoder 280 replaces blocks 240, 252 in FIG. 8.

FIG. 12 illustrates an example of a joint decoder 280 that corresponds to the joint encoder 190 illustrated in FIG. 10. The first sub-set 111 of audio signals 110 and the one or more transport audio signals 151 and metadata 153 are produced using the joint decoder 280.

The data stream including the encoded first set 121 of audio signals 110 and the encoded second set 122 of audio signals is de-multiplexed at block 270 to provide encoded residual signals 271, encoded downmix signals 273, encoded residual coefficients 275 and encoded metadata 277.

The encoded residual signals 271 are forwarded to block 272 for decoding. This reproduces residual signals 192.

The encoded downmix signals 273 are forwarded to block 274 for decoding. This reproduces the downmix signals 194.

The encoded residual coefficients 275 are forwarded to block 276 for decoding. This reproduces the residual coefficients 196.

The encoded metadata 277 is forwarded to block 278 for decoding. This reproduces the metadata 153.

Block 279 processes the downmix signals 194 using the prediction coefficients 196 and the residual signals 192 to reproduce the first set 111 of audio signals 110 and the one or more transport audio signals 151.

The one or more transport audio signals 151 and the metadata 153 are output with the metadata 153 to block 254 in FIG. 11.

The apparatus 200 illustrated in FIG. 13 is similar to the apparatus 100 illustrated in FIG. 7. Possible interdependencies between the first set 111 of audio signals 110 and the processed (transport) audio signals 151 can be taken into account. In this example, joint processing occurs at block 133 before separation of the audio signals 110.

The pre-processing begins by determining at block 132 the first sub-set 111 of audio signals 110. The control information 180 is provided to block 133. Block 133 first performs pre-processing of the audio signals 110 in the first sub-set 111 and at least some of the remaining audio signals 110 in the second sub-set 112.

For example, a center channel audio signal 110 in the first sub-set 111 can be subtracted from the front left channel audio signal 110 and the front right channel audio signal 110 if it is determined that the center channel audio signal 110 is coherently present also in the front left and front right channel audio signals 110.

As another example, prediction and residual processing may be applied between the center channel audio signal 110 and the front left channel audio signal 110 and the front right channel audio signal 110, as was described with reference to FIG. 10.

The pre-processing results in modified multichannel audio signals 110 and pre-processing coefficients 181 that contain information on what kind of pre-processing was applied.

Block 133 outputs pre-processing coefficients 181, the first set 111 of audio signals 110 as one stream and the second set 112 of audio signals as a second stream.

The pre-processing coefficients 181 can be provided separately to the control information 180 or can be provided with, or as part of, the control information 180.

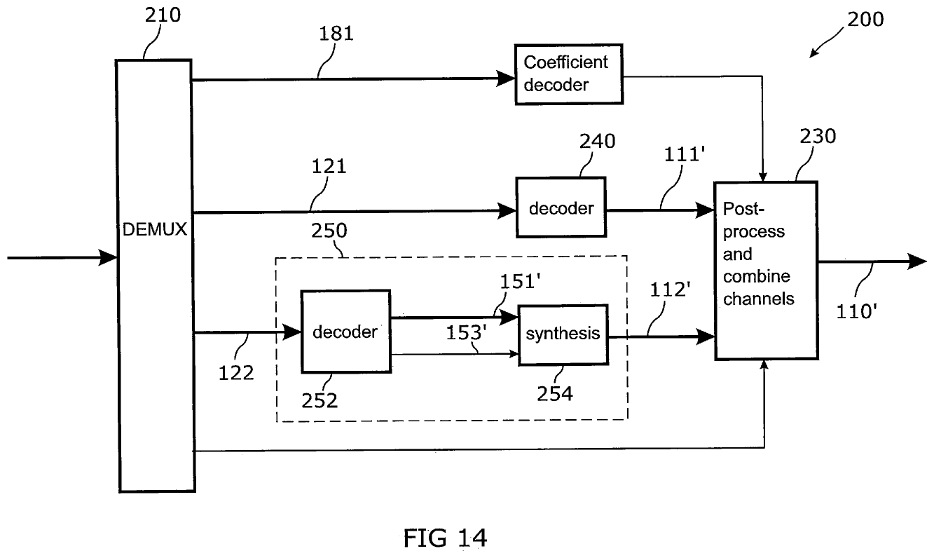

FIG. 14 illustrates a decoder apparatus 200 for use with the encoder apparatus 100 illustrated in FIG. 13. The apparatus 200 illustrated in FIG. 14 is similar to the apparatus 200 illustrated in FIG. 8. However, in FIG. 14, the combination 230 of the first set 111′ of audio signals 110 and the second set 112′ of audio signals 110 uses the coefficients 181 for the combination and recovery of the synthesized original multi-channel signals 110′. The first sub-set 111 of audio signals and the second sub-set 112 of audio signals 110 are post-processed before they are combined. The post-processing is such that it inverts the pre-processing that was applied in the encoder. For example, the center channel audio signal 110 may be added back to the front left channel audio signal 110 and the front right channel audio signal 110, if the pre-processing coefficients 181 indicate that such pre-processing was applied in the encoder.

FIG. 15 illustrates an example of a controller 500. The controller can provide the functionality of the encoding apparatus 100 and/or the decoding apparatus 200.

Implementation of a controller 500 may be as controller circuitry. The controller 500 may be implemented in hardware alone, have certain aspects in software including firmware alone or can be a combination of hardware and software (including firmware).

As illustrated in FIG. 15 the controller 500 may be implemented using instructions that enable hardware functionality, for example, by using executable instructions of a computer program 506 in a general-purpose or special-purpose processor 502 that may be stored on a computer readable storage medium (disk, memory etc) to be executed by such a processor 502.

The processor 502 is configured to read from and write to the memory 504. The processor 502 may also comprise an output interface via which data and/or commands are output by the processor 502 and an input interface via which data and/or commands are input to the processor 502.

The memory 504 stores a computer program 506 comprising computer program instructions (computer program code) that controls the operation of the apparatus 100, 200 when loaded into the processor 502. The computer program instructions, of the computer program 506, provide the logic and routines that enables the apparatus to perform the methods illustrated in FIGS. 1 to 14. The processor 502 by reading the memory 504 is able to load and execute the computer program 506.

The apparatus 100 can therefore comprise:

at least one processor 502; and
at least one memory 504 including computer program code
the at least one memory 504 and the computer program code configured to, with the at least one processor 502, cause the apparatus 100, 200 at least to perform:
identifying at least one audio signal to separate from multi-channel audio signals 110;
separating, based on the identified at least one audio signal, the multiple audio signals into at least a first sub-set 111 of the multiple audio signals and a second sub-set 112 of the multiple audio signals, wherein the first sub-set 111 comprises the identified at least one audio signal and the second sub-set 112 comprises the remaining audio signals of the received multi-channel audio signals 110;
analyzing the remaining audio signals of the second sub-set 112 of audio signals to determine one or more transport audio signals 151 and metadata 153; and
enabling encoding of the at least one audio signal, transport audio signal 151 and metadata 153.

The apparatus 200 can therefore comprise:

at least one processor 502; and
at least one memory 504 including computer program code
the at least one memory 504 and the computer program code configured to, with the at least one processor 502, cause the apparatus 100, 200 at least to perform:
decoding 240, 250 received encoded data 160, comprising at least one audio signal 111, one or more transport audio signals 151 and metadata 153, to provide a decoded at least one audio signal 111′ as a first sub-set 111′ of audio signals 110′, a decoded one or more transport audio signals 151′ and decoded metadata 153′;
synthesizing 254 the decoded one or more transport audio signals 151′ and the decoded metadata 153′ to provide a second sub-set of audio signals 112′;
identifying multi-channel indices of the at least one audio signal and/or the set of audio signals; and
combining 230 at least the decoded at least one audio signal 111′ (the first sub-set) and the second sub-set of audio signals 112′ to provide multi-channel audio signals 110′.

As illustrated in FIG. 16, the computer program 506 may arrive at the apparatus 100, 200 via any suitable delivery mechanism 508. The delivery mechanism 508 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 506. The delivery mechanism may be a signal configured to reliably transfer the computer program 506. The apparatus 100, 200 may propagate or transmit the computer program 506 as a computer data signal.

The computer program 506 can comprise program instructions for causing an apparatus to perform at least the following or for performing at least the following identifying at least one audio signal to separate from multi-channel audio signals 110;

separating, based on the identified at least one audio signal, the multiple audio signals 110 into at least a first sub-set 111 of the multiple audio signals and a second sub-set 112 of the multiple audio signals, wherein the first sub-set 111 comprises the identified at least one audio signal and the second sub-set 112 comprises the remaining audio signals of the received multi-channel audio signals 110;
analyzing the remaining audio signals of the second sub-set 112 of audio signals to determine one or more transport audio signals 151 and metadata 153; and
enabling encoding of the at least one audio signal, transport audio signal 151 and metadata 153.

The computer program 506 can comprise program instructions for causing an apparatus to perform at least the following:

decoding 240, 250 received encoded data 160, comprising at least one audio signal 111, one or more transport audio signals 151 and metadata 153, to provide a decoded at least one audio signal 111′ as a first sub-set 111′ of audio signals 110′, a decoded one or more transport audio signals 151′ and decoded metadata 153′;
synthesizing 254 the decoded one or more transport audio signals 151′ and the decoded metadata 153′ to provide a second sub-set of audio signals 112′;
identifying multi-channel indices of the at least one audio signal and/or the set of audio signals; and
combining 230 at least the decoded at least one audio signal 111′ (the first sub-set) and the second sub-set of audio signals 112′ to provide multi-channel audio signals 110′.

The computer program instructions may be comprised in a computer program, a non-transitory computer readable medium, a computer program product, a machine readable medium. In some but not necessarily all examples, the computer program instructions may be distributed over more than one computer program.

Although the memory 504 is illustrated as a single component/circuitry it may be implemented as one or more separate components/circuitry some or all of which may be integrated/removable and/or may provide permanent/semi-permanent/dynamic/cached storage.

Although the processor 502 is illustrated as a single component/circuitry it may be implemented as one or more separate components/circuitry some or all of which may be integrated/removable. The processor 502 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software fora programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:

(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 1 to 14 may represent steps in a method and/or sections of code in the computer program 506. The illustration of a particular order to the blocks does not necessarily imply that there is a required or preferred order for the blocks and the order and arrangement of the block may be varied. Furthermore, it may be possible for some blocks to be omitted.

At mid bitrates (for example around 128 kbps), there are clear perceivable audio quality benefits using the above described approaches. This is especially so when the channel-based multichannel audio has a large number of channels. Separate coding of one or a few channels provides much more “stable” image, for example, for the main dialogue, and at the same time the spatial image gets “wider” as the spatial parameters do not have to “waste” a majority of the parameter space representing, for example, the main dialogue. The increase in the bitrate, if any, is manageable.

Where a structural feature has been described, it may be replaced by means for performing one or more of the functions of the structural feature whether that function or those functions are explicitly or implicitly described.

As used here ‘module’ refers to a unit or apparatus that excludes certain parts/components that would be added by an end manufacturer or a user.

The apparatus 100 can be a module. The apparatus 200 can be a module.

The component block of the apparatus 100 can be modules. The component block of the apparatus 200 can be modules. The controller 500 can be a module.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one.” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer and exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus comprising:
at least one processor; and
at least one non-transitory memory including a computer program code,
the at least one memory and the computer program code configured to, with the at least one processor, cause the apparatus at least to:
receive multi-channel audio signals;
identify at least one audio signal to separate from the multi-channel audio signals;
separate, based on the identified at least one audio signal, the multiple audio signals into at least a first sub-set of audio signals and a second sub-set of audio signal, wherein the first sub-set comprises the identified at least one audio signal and the second sub-set comprises the remaining audio signals of the received multi-channel audio signals;
analyze the remaining audio signals of the second sub-set of audio signals to determine one or more transport audio signals and metadata; and
encode the at least one audio signal, the one or more transport audio signals and metadata.

2. An apparatus as claimed in claim 1, wherein the first sub-set of audio signals is a fixed sub-set of the multiple audio signals and the second sub-set of audio signals is a fixed sub-set of the multiple audio signals.

3. An apparatus as claimed in claim 2, wherein the first sub-set consists of a center loudspeaker channel signal and/or a pair of stereo channel signals and/or the first sub-set of audio channels comprises one or more dominantly voice audio channel signals.

4. An apparatus as claimed in claim 1, wherein first sub-set of audio signals is a variable sub-set of the multiple audio signals and the second sub-set of audio signals is a variable sub-set of the multiple audio signals.

5. An apparatus as claimed in claim 4, wherein a count of the first sub-set of audio signals is variable and/or wherein a composition of the first sub-set of audio signals is variable.

6. An apparatus as claimed in claim 1 wherein the first sub-set of audio signals are signals that are determined to satisfy a first criterion and the second sub-set of audio signals are signals that are determined not to satisfy the first criterion.

7. An apparatus as claimed in claim 6, wherein the first criterion is dependent upon one or more first audio characteristics of the audio signals, wherein the first sub-set of audio signals share the one or more first audio characteristics and second sub-set of audio signals do not share the one or more first audio characteristics.

8. An apparatus as claimed in claim 6, wherein the first criterion is dependent upon one or more spectral properties of the audio signals, wherein at least some of the first sub-set of audio signals share the one or more spectral properties and the second sub-set of audio signals do not share the one or spectral properties.

9. An apparatus as claimed in claim 7, wherein the one or more first audio characteristics comprise an energy level of an audio signal, wherein the first sub-set of audio signals each have an energy level greater than any of the second sub-set of audio signals.

10. An apparatus as claimed in claim 7, wherein the one or more first audio characteristics comprise audio signal correlation,
wherein the first sub-set of audio signals each have greater cross-correlation with audio signals of the first sub-set than audio signals of the second sub-set, or
wherein the one or more first audio characteristics comprise audio signal de-correlation, wherein at least some of the first sub-set of audio signals all have low cross-correlation with other audio signals of the first sub-set and with the audio signals of the second sub-set, or
wherein the one or more first audio characteristics comprise audio characteristics defined with an audio classifier, wherein at least some of the first sub-set of audio signals convey voice and the audio signals of the second sub-set do not.

11. An apparatus as claimed in claim 1, wherein the multi-channel audio signal comprises multiple audio signals where each audio signal is for rendering audio via a different output channel.

12. An apparatus as claimed in claim 1, wherein the count of the first sub-set is dependent upon an available bandwidth.

13. An apparatus as claimed in claim 1, wherein the at least one memory and the computer program code are configured to, with the at least one processor, cause the apparatus to analyze the remaining audio signals of the second sub-set of audio signals to determine transport audio signals and metadata comprises analyzing the second sub-set of audio signals but not the first sub-set of audio signals.

14. An apparatus as claimed in claim 13, wherein the metadata is configured to at least one of:
parameterize time-frequency portions of the second sub-set of audio signals; or
encode at least spatial energy distribution of a sound field defined with the second sub-set of audio signals.

15. (canceled)

16. An apparatus as claimed in claim 1, wherein the at least one memory and the computer program code are configured to, with the at least one processor, cause the apparatus to provide control information that at least identifies at least one of:
which one of the multiple audio signals are comprised in the first sub-set of audio signals; or
processed audio signals produced with the analysis.

17. (canceled)

18. An apparatus as claimed in claim 1, wherein the analysis of the second sub-set of audio signals provides one or more processed audio signals and metadata, wherein the one or more processed audio signals and metadata are jointly encoded with the first sub-set of audio signals or the one or more processed audio signals and metadata are jointly encoded but encoded separately to the first sub-set of audio signals.

19. A method comprising coding of multi-channel audio signals, comprising:
identifying at least one audio signal to separate from the multi-channel audio signals;
separating, based on the identified at least one audio signal, the multiple audio signals into at least a first sub-set of the multiple audio signals and a second sub-set of the multiple audio signals, wherein the first sub-set comprises the identified at least one audio signal and the second sub-set comprises the remaining audio signals of the received multi-channel audio signals;
analyzing the remaining audio signals of the second sub-set of audio signals to determine one or more transport audio signals and metadata; and
encoding the at least one audio signal, transport audio signal and metadata.

20. An apparatus comprising:
at least one processor; and
at least one non-transitory memory including a computer program code,
the at least one memory and the computer code configured to, with the at least one processor, cause the apparatus at least to:
receive encoded data comprising at least one audio signal, one or more transport audio signals and metadata for decoding;
decode the received encoded data to decode the at least one audio signal, the one or more transport audio signals and the metadata;
synthesize the decoded one or more transport audio signals and the decoded metadata to provide a set of audio signals;
identify multi-channel indices of the at least one audio signal and/or the set of audio signals; and
combine using the indices at least the decoded at least one audio signal and the set of audio signals to provide multi-channel audio signals.

21. (canceled)

22. An apparatus as claimed in claim 18 comprising a joint decoder for decoding the received encoded data to decode the at least one audio signal, the one or more transport audio signals and the metadata or comprising a first decoder for decoding at least a first sub-set of the received encoded data to provide the at least one audio signal, and a second, different, decoder for decoding at least a second sub-set of the received encoded data to provide the one or more transport audio signals and the metadata.

23. A method comprising:
receiving encoded data comprising at least one audio signal, one or more transport audio signals and metadata for decoding;
decoding the received encoded data to decode the at least one audio signal, the one or more transport audio signals and the metadata;
synthesizing the decoded one or more transport audio signals and the decoded metadata to provide a set of audio signals; and
combining at least the decoded at least one audio signal and the set of audio signals to provide multi-channel audio signals.

24. (canceled)
